(19) United States
(12) Patent Application Publication
(10) Pub. No.: US 2001/0011680 A1
(43) Pub. Date: Aug. 9, 2001

(54) SELF-SERVICE KIOSK WITH BIOMETRIC VERIFICATION AND/ OR REGISTRATION CAPABILITY

(76) Inventors: JOHN SOLTESZ, BROOKFIELD, OH (US); RENEE KELLER, BROOKFIELD, OH (US)

Correspondence Address: BACON & THOMAS, 625 SLATERS LANE 4TH FLOOR, ALEXANDRIA, VA, 223141176

(21) Appl. No.: 09/207,108

(22) Filed: Dec. 8, 1998

Related U.S. Application Data
(60) Provisional application No. 60/067,876, filed on Dec. 8, 1997.

(51) Int. Cl. G06F 17/60

(52) U.S. Cl. 235/379

(57) ABSTRACT

A self-service kiosk includes a biometrics data input for inputting biometrics of a user of the kiosk, a reader for recovering biometrics data stored on a portable storage device such as an optical card, the portable storage device also containing information necessary to carry out a transaction, and a controller capable of comparing the input biometrics data with the stored biometrics data and authorizing a transaction based on a result of the comparison. Alternatively, or in addition to the above, the self-service kiosk may include a device for capturing an image of a customer/registrant, a biometrics capture device, and a data input device for enabling registration information to be entered and stored on a portable storage device such as an optical memory card together with the image and/or biometrics data, the portable storage device being dispensed to the customer/registrant immediately upon registration.

### CROSS-REFERENCE TO RELATED APPLICATIONS

This application claims the benefit of U.S. Provisional Application No. 60/067,876, filed Dec. 8, 1997.

### BACKGROUND OF THE INVENTION

1. Field of the Invention

This invention relates to a kiosk of the type capable of handling commercial transactions with full verification of the identity of the user. The kiosk of the invention is especially suitable for use as an Automated Teller Machine (ATM), although the invention may be used for other types of transactions such as airline ticketing, drivers license renewals, vending, Internet or telephone system access, and so forth, with on-site verification and/or authentication of the user being carried out in real time using biometrics such as fingerprint or voice analysis.

The invention also relates to a kiosk equipped to provide self-service registration and dispensing of optical memory cards having stored thereon authentication information such as an image of the registrant and/or biometric data.

2. Description of Related Art

Transaction kiosks which delivery products or services in response to insertion of a transaction card have been used for many years as ATMs and are becoming increasingly popular for other transactions such as vending of gasoline at self-service pumps, issuing of boarding passes for airline shuttles, and other transactions in which the financial information necessary to complete the transaction is encoded in some manner onto a transaction card. In the past, there has been no way to verify the identity of the card holder, except through use of a personal identification number (PIN) or password, which is entered by the cardholder via a key board or other input device on the kiosk and compared with a personal identification number or password stored on the card or in a local or remote database. Because the PIN or password can become known to unauthorized users, through fraud or coercion, this method of verifying transactions has long been recognized as inadequate.

Recent advances in computer technology has made possible more sophisticated verification methods. In particular, it previously been proposed to use biometrics information as a means of verifying the identity of a transaction card holder. U.S. Pat. No. 5,756,978, issued May 26, 1998, and incorporated by reference herein, describes a transaction terminal which, although primarily designed to facilitate in-person cardholder verification by displaying a digital photograph of the card holder stored in encrypted form on an optical transaction card, mentions the possibility of adding biometrics capabilities to the terminal. The present invention extends this concept by providing the biometrics capabilities in a freestanding self-service kiosk intended to be used for unattended transactions. In addition, the present invention contemplates a self-service kiosk capable of collecting an image of the user and/or other biometric data and of dispensing optical memory cards that can be used in connection with a terminal of the type described in the above-cited U.S. Patent.

The technology involved in biometrics is well-known. The term “biometrics” refers to the use of unique features of a persons body to identify that person, and includes fingerprint analysis, voice or speech pattern recognition, and measurement of body parts such as the person's eye. Fingerprint analysis has, in particular, been used for many years as an identification tool, and a variety of devices are available to allow a person to place his or hand on a plate and capture the fingerprints in digital electronic form. Other products are available for comparing the input fingerprints to images of fingerprints stored in a database and verifying the identity of the person based on the results of the comparison. Because fingerprints are extremely difficult to forge, this method of identification is generally considered to be secure, allowing a transaction device to at least ensure that the person presenting the card is the authorized cardholder.

The principal problem with the use of biometrics to verify cardholders in this context is the problem of communicating the biometrics information to the database, and communicating the results back to the site of the transaction. Storage of biometrics information on site is generally impractical, and is certainly inefficient when the card can be used with different kiosks, each of which would be required to store the necessary information. As a result, the use of biometrics information is limited to transaction devices which are networked or equipped to communicate with a remote database. This limits the range of applicability of biometrics verification to use in connection with existing networks and locations with appropriate infrastructure, thereby excluding much of the world, and also limits the speed at which transactions can be conducted.

### SUMMARY OF THE INVENTION

It is accordingly a first objective of the invention to overcome the problems of the prior art by providing a kiosk capable of biometric verification without connection to a central database or the need for an on-site database of biometrics data.

It is a second objective of the invention to provide a self-service kiosk with biometrics verification at a reduced cost and yet which provides a greater range of services than a conventional self-service kiosk.

It is a third objective of the invention to provide a self-service kiosk which requires a relatively small space, is simple to operate, and can be used for a wide variety of transactions and even shared by multiple service providers.

It is a fourth objective of the invention to provide a kiosk equipped to provide self-service registration of a card having stored thereon an image of the registrant and/or biometric data, and of dispensing such a card to the registrant.

These objectives are accomplished, in accordance with the principles of a first preferred embodiment of the invention, by providing a self-service kiosk with a biometrics reader device for obtaining biometrics data from a customer present at the kiosk, a second reader device for inputting biometrics data stored on a portable storage means carried by the user, and circuitry, software, or a combination of circuitry and software for comparing the customer input biometrics data with the stored biometrics data and authorizing a transaction based on the results of the transaction.

In especially advantageous version of the first preferred embodiment of the invention, the second reader device is an optical card reader, and the stored biometrics data is stored on a write once read many times (WORM) optical card.

According to variations of the first preferred embodiment of the invention, the self-service kiosk includes, in addition to a biometrics input device and optical card reader, a display screen, a microprocessor and operating system software, an on-site storage device such as a hard disk drive for storing applications programs, an operator input in the form of a keyboard, touch screen, trackball, or the like, a printer capable of printing receipts, reports, coupons, bar codes, advertisements, or the like, a manual insertion manual card reader for compatibility with existing magnetic stripe based cards, and network connection capabilities.

The optional network connection capabilities of the further preferred embodiments enable the kiosk to be used for Internet connections through a proxy server or via a direct connection to an Internet service provider, to transmit diagnostics, accounting reports, and the like, while maintaining the real-time on-site verification capabilities of the kiosk, and without having to carry heavy volumes of biometrics data.

Because the kiosk of the preferred embodiments does not require network connections, or can be used with applications independent protocols such as PPP/SLIP, advanced Java, or ActiveX, it has the further advantage of allowing applications issuers to maintain control over the development and modification of their proprietary programs.

The objectives of the invention are also achieved, in accordance with the principles of a second preferred embodiment of the invention, by providing a self-service kiosk with an image capture device and/or a biometrics reader device for obtaining biometrics data from a registrant present at the kiosk, a data input device arranged to enable the registrant to enter registration information, a device arranged to store an image of the registrant and/or other biometrics data on a memory card or other portable data storage medium, and a dispenser for dispensing the memory card or other portable data storage medium to the registrant.

In an especially advantageous version of the second preferred embodiment of the invention, the image and/or biometrics data storage device is an optical card read/write unit, and the stored biometrics data is stored on a write once read many times (WORM) optical card.

According to variations of the second preferred embodiment of the invention, the self-service kiosk includes, in addition to a biometrics input device and optical card read/write unit, a display screen, a microprocessor and operating system software, and an on-site storage device such as a hard disk drive for storing applications programs. The data input device is preferably in the form of a keyboard, touch screen, trackball, or the like, and may include a printer capable of printing receipts, reports, coupons, bar codes, advertisements, or the like, and network connection capabilities.

The optional network connection capabilities of the further variations of both preferred embodiments of the invention enable the kiosk to be used for Internet connections through a proxy server or via a direct connection to an Internet service provider, to transmit diagnostics, accounting reports, and the like, while maintaining the real-time on-site verification capabilities of the kiosk, and without having to carry heavy volumes of biometrics data.

Advantageously, the kiosks of both of the above-described embodiments of the invention may be arranged to include multiple transaction processing or registration programs, and each card may have stored thereon data sets related to one or more of the different transaction processing or registration programs, as well as software that may be used by the kiosk to process one or more of the data sets. Because of the vast storage capabilities of optical cards and other advanced media, it is possible to transfer much of the memory requirements for the kiosk to individual cards, and if integrated circuitry is also included in the cards, much of the required data processing load can also be transferred to individual cards.

### BRIEF DESCRIPTION OF THE DRAWINGS

FIG. 1 is a perspective view of a kiosk constructed in accordance with the principles of a first preferred embodiment of the invention.

FIG. 2 is a block diagram showing principal functional components of the verification/authentication portion of the kiosk illustrated in FIG. 1.

FIG. 3 is a perspective view of a kiosk constructed in accordance with the principles of a second preferred embodiment of the invention.

FIG. 4 is a block diagram showing principal functional components of the self-service registration kiosk illustrated in FIG. 3.

### DETAILED DESCRIPTION OF THE PREFERRED EMBODIMENTS

As illustrated in FIG. 1, a self-service kiosk constructed in accordance with the principles of a first preferred embodiment of the invention includes a modular housing 1 containing a card reader device, represented in FIG. 1 by card insertion slot 2, a biometric input device 3, a printer, represented in FIG. 1 by a printed materials output 4, a keyboard 5 or other manual input device, a display 6, and controller hardware, firmware, and/or software 7.

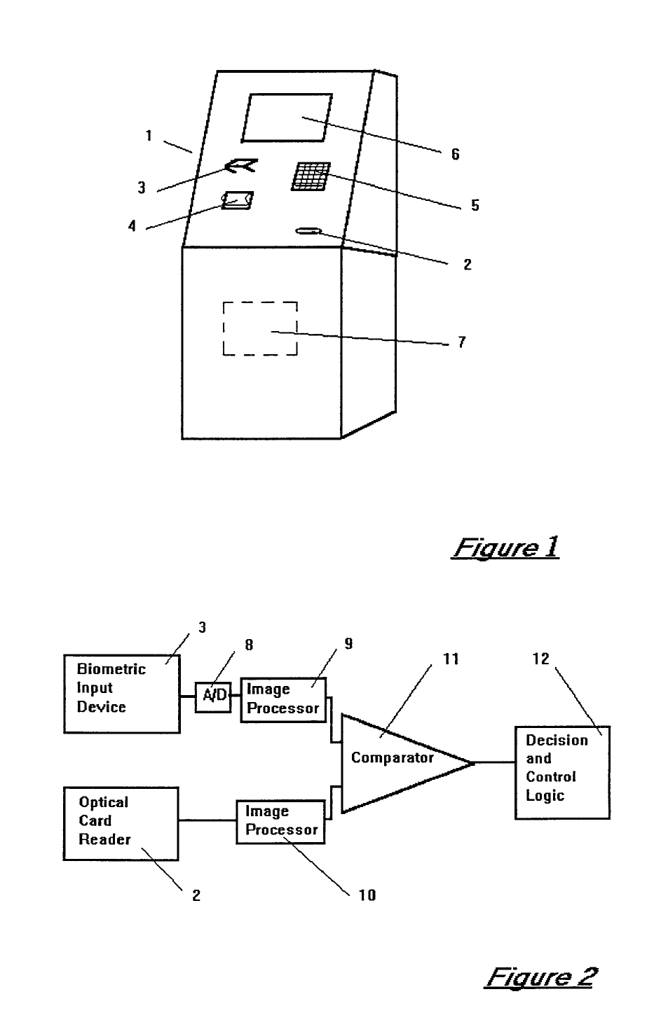

As illustrated in FIG. 2, the controller includes an analog/digital converter 8 connected to the biometrics input device, which may in some cases be integrated with the device, and image processing circuitry 9 and 10 for the inputs from the optical card reader and biometric input device in order to enable comparison of the inputs in a comparator module 11, the results being supplied to a decision and control logic module 12 which decides whether to authorize a transaction based on the results of the comparison, and which then initiates other functions associated with the transaction or services to be performed by the kiosk.

The card reader may correspond to the card reader used in the Zerco Systems ZS-1200 terminal, currently available from Zerco Systems International of Brookfield, Ohio, or any other optical card reader capable of reading a credit card sized WORM-type optical card, although the invention is not in principle limited to a particular type of portable storage device, so long as the storage device can conveniently be carried by a customer and store sufficient biometrics information for verification and/or authentication purposes. For example, the card reader could be arranged to support DELA standard format optical cards, with 1.6 or 4.1 MB storage capacity unformatted and 1.1 or 2.8 MB formatted storage capacity, or other types of optical cards as the technology becomes available.

The biometrics input device is, in the illustrated embodiment, a fingerprint reader, several of which are currently commercially available, although again the invention is not limited to a particular type of biometrics input device, and can be adapted for use with one or more different biometrics inputs, depending on the level of security required. Software for digitizing and processing the inputs, processing corresponding biometrics data stored on the optical card read by the optical card reader, and comparing the processed data in order to authorize a transaction are also available and within the capabilities of the skilled artisan to adapt to a particular hardware configuration.

The display screen, keyboard or other input device, and controller hardware and software are, with the exception of the context in which they are used, and in particular their combination with devices capable of providing on-site real-time identity verification and/or authentication using biometrics, also conventional.

For example, the controller may include a PC compatible Pentium™ 120, 133, or 200 MHz MMX processor, 16 MHz RAM upgradeable to 128 MB RAM, a 1.2 GB hard disk drive upgradeable to 4 GB, a 2 MB video RAM upgradeable to 4 MB, 33.6K BAUD modem upgradeable to 56k, a Fast Ethernet interface card with 10 Base-T@ 10 MBps (Cat 5) for LAN/WAN connectivity, and a SCSI II interface, all of which can easily be contained in a kiosk of virtually any desired dimensions, while the video display can be in the form of a 15″ monitor or touch screen, the printer can be a built-in thermal printer capable of printing 11 lines per second on 3″ wide paper for printing receipts, reports, coupons, bar codes, advertisements and promotional materials, and so forth. Preferably, a magnetic card reader is also included, as in the terminal described in U.S. patent application Ser. No. 08/640,675 cited above, which is capable of reading ISO 7811 tracks 1, 2, and 3, or 1 and 2 simultaneously, LoCo or HiCo, both surface applied and embedded, to ensure compatibility with existing magnetic stripe based cards.

It will of course be appreciated by those skilled in the art are exemplary only, and that any of the specifications can be changed to meet the needs of the application and to keep up with advances in processor, memory, and communications technology. This is also true of software used in the kiosk, which in the above described system may be run on a Windows NT 4.0™ platform, or be compatible with NetWare, Novell, UNIX, Macintosh, Banyan VINES, LAN Manager 2.x, Window 95, or any other current or future operating system software, and which may optionally include a PPP/SLIP, advanced Java, and/or ActiveX capable communications program to enable connection to the Internet, either for use in providing Internet services to customers or to communicate with a service provider for accounting or diagnostic purposes, or for downloading or uploading new programs following authentication. Internet connectivity can be provided by direct connection to a developer host through a COM port, network connection through the Ethernet, Internet connections through a modem or proxy server, or direct dial-up through a modem.

The kiosk of the first preferred embodiment and variations thereof can be used with a Developers Tool Kit developed by Zerco Systems International to enable code to be “dropped” into high level RAD (rapid application development) languages such as Visual Basic, Visual C++, or Delphi, allowing developers to use only high level programming, saving time and money when expanding or developing applications for the kiosk, the open architecture of the kiosk allowing applications issuers to maintain control over the development and modification of their proprietary programs, and allowing customization of the kiosk by individual issuers, acquirers, and/or individual merchants, with different software being allowed to coexist on one kiosk through appropriate memory management.

Alternatively, it is possible to transfer much of the memory requirements for the kiosk to individual cards by storing software usable by the kiosk on the cards themselves. In addition, inclusion of integrated circuitry on the cards would permit sharing of processing responsibilities or load between the kiosk and the cards. Sharing of software and/or processing capabilities between the card and the kiosk can both increase transactional security and the flexibility of the kiosk, with each card being capable of storing one or more application programs for one or more different types of transactions.

In addition to the security provided by the on-site real-time biometrics verification/authentication capabilities, the kiosk of the first preferred embodiment may also include PIN/password protection using the keypad, with the entered PIN/password being compared with a PIN/password stored on the optical card that contains the biometric information, in a database internal to the kiosk, or in a remote database as is currently conventional. Furthermore, the data on the card can be protected by encryption, and decryption software or firmware can be provided in the kiosk in the manner described in U.S. Pat. No. 5,027,401 and the above cited U.S. Pat. No. 5,756,978, and used in the Zerco Systems ZS-1200 terminal.

In summary, the first preferred embodiment of the invention provides a self-service kiosk in which real-time on-site authentication and/or verification functions are provided by comparison between data input via a biometrics input device and data stored on a portable storage device, such as an optical card, carried by the user. As a result, communications with a remote database are not required in order to perform the verification and/or authentications, allowing the kiosk to be used as a stand-alone device situated in remote locations, or alternatively as an advanced consumer service kiosk in which optional communications and computing devices can be dedicated to enhancement of services provided by the kiosk rather than to authentication verification functions.

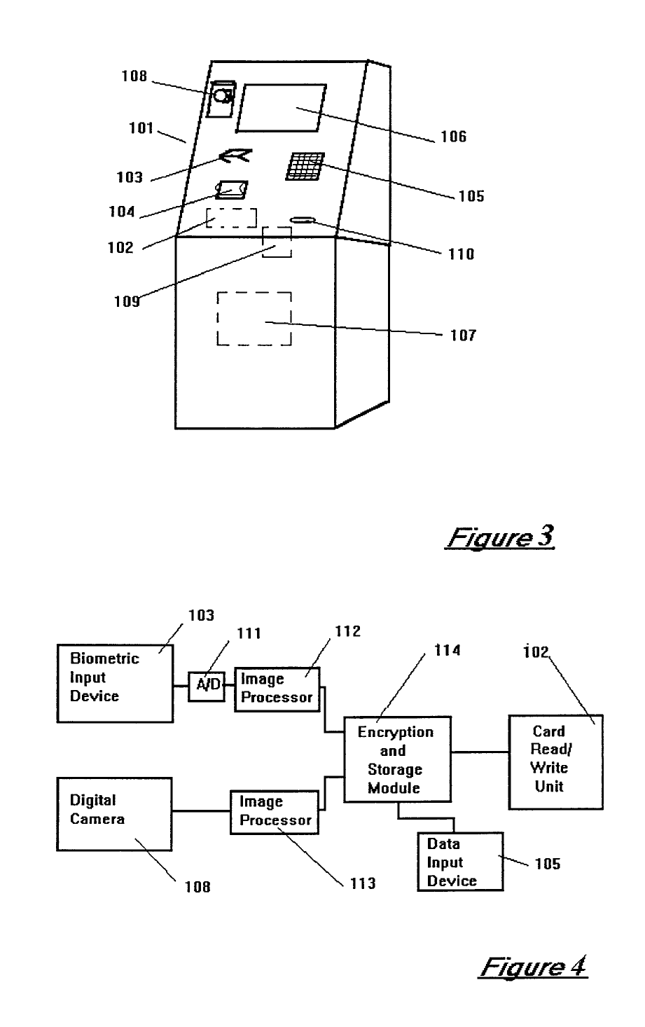

As illustrated in FIG. 3, a self-service kiosk constructed in accordance with the principles of a second preferred embodiment of the invention includes a modular housing 101 containing a card read/write device 102, a biometric input device 103, a printer, represented in FIG. 1 by a printed materials output 104, a keyboard 105 or other manual input device, a display 106, and controller hardware, firmware, and/or software 107. In addition, the kiosk of this embodiment of the invention includes a camera 108 for capturing a digital image of a subject, and a mechanism 109 for feeding blank cards into the card read/write reader, ejecting them from the reader, and dispensing them to customer/registrants through a slot 110 or other opening.

As illustrated in FIG. 4, the controller includes an analog/digital converter 111 connected to the biometrics input device, which may in some cases be integrated with the device, and image processing circuitry 112 and 113 for processing inputs from the camera and biometric input devices in order to enable the inputs to be stored on an optical memory card by data encryption and storage module 114, which may use the data encoding and encryption method described in U.S. Pat. No. 5,027,401. The controller also is arranged to store data entered via the input device 105 for storage on the card and, optionally, to transmit selected registration information to a central data base, and to control the display 106 to prompt the user to following a registration routine or procedure.

Although not shown, the kiosk may be equipped with a conventional credit card reader to enable payment for the card to be made, with communications capabilities included so that the payment information can be transmitted and verified, although it will be appreciated by those skilled in the art that the memory cards dispensed through slot 110 could be entirely self contained, with no need to transmit information to a central data based, particularly if the card is to be used solely as an identity card and not for storage of payment information, which is within the scope of the invention. In addition, the kiosk may include a magnetic stripe encoding unit in case the dispensed cards include magnetic stripes for compatibility with existing systems.

Furthermore, the self-service kiosk of this preferred embodiment of the invention may include an arrangement for printing on the card visual confirmation of the data stored therein, and/or other information associated with the card issuer or registrant, prior to dispensing the card.

The optical card read/write unit and enrollment software may correspond to the card read/write unit and software used in the Zerco Systems enrollment workstation currently available from Zerco Systems International of Brookfield, Ohio, or to any other optical card read/write unit and software capable of storing information on a credit card sized WORM-type optical card, the invention being in principle not limited to a particular type of portable storage device and software, so long as the storage device can conveniently be carried by a customer and store sufficient biometrics information for verification and/or authentication purposes, and so long as the software is capable of supporting the video camera, biometrics reader, and registrant input devices, and of prompting the registrant to take the necessary steps to input the required information.

The biometrics input device of this embodiment of the invention is, as in the first preferred embodiment, a fingerprint reader, although again the invention is not limited to a particular type of biometrics input device, and can be adapted for use with one or more different biometrics inputs. The display screen, keyboard or other input device, and controller hardware and software may also be similar to the corresponding elements used in the first preferred embodiment of the invention, with the addition of a video camera and video capture board, numerous examples of which are currently available. In addition, the kiosk of the second preferred embodiment of the invention may also be used with the above-described Developers Tool Kit available from Zerco Systems International, and may be arranged to share software or processing capabilities with cards having built-in processing capabilities and/or that are capable of storing one or more application programs for use by the kiosk in processing different types of transactions.

In summary, the second preferred embodiment of the invention provides a self-service kiosk capable of collecting registration information, biometrics data, and/or an image of the registrant, and of storing the information in, preferably, encrypted form on a portable storage device such as an optical memory card for use in a identification verification and/or authentication system of the type described in U.S. Pat. No. 5,756,978, or in other optical memory card based systems, and of dispensing the cards to the registrant immediately upon registration. The kiosk of this embodiment of the invention can be used as a stand-alone device situated in remote locations, or alternatively as an advanced consumer service kiosk in which optional communications and computing devices can be dedicated to enhancement of services provided by the kiosk.

Having thus described a preferred embodiment of the invention in sufficient detail to enable those skilled in the art to make and use the invention, it is nevertheless intended that the above description not be taken as limiting, but rather that the invention be defined solely by the claims which will be appended upon conversion of this provisional application into a utility application under 35 USC §111(a).

We claim:

1. A stand-alone biometrics verification arrangement, comprising:
a housing;
a biometrics reader device arranged to obtain biometrics data from a customer present at the housing;
a second reader device for inputting biometrics data stored on a portable storage device carried by the use;
means for comparing customer input biometrics data with stored biometrics data and authorizing a transaction based on results of the transaction,
whereby authorization of transactions based on said input and stored biometrics data may be carried out without connection to a central database or an on-site database of biometrics data.

2. An arrangement as claimed in claim 1, wherein said portable storage device is a write once read many times (WORM) optical card.

3. An arrangement as claimed in claim 1, further comprising, within said housing, a display screen, a microprocessor, operating system software, and an on-site storage device for storing applications programs, whereby processing of data stored on the portable storage device is carried out by software stored in said on-site storage device and executed by the microprocessor, results of said processing being displayed on said display screen.

4. An arrangement as claimed in claim 3, further comprising a printer situated within said housing for printing results of said processing.

5. An arrangement as claimed in claim 1, further comprising, within said housing, a display screen, a microprocessor, and operating system software, and wherein said portable storage device has stored therein applications software for execution by said microprocessor, results of said processing being displayed on said display screen.

6. An arrangement as claimed in claim 1, further comprising network connections for enabling communications with an external computer network, while maintaining a real-time on-site verification capability.

7. A stand-alone kiosk with registration capabilities, comprising:
a housing;
means for obtaining personal data from a registrant present at the kiosk;
a data input device arranged to enable the registrant to enter registration information;
a device arranged to store said personal on a portable data storage medium; and
a dispenser for dispensing the portable data storage medium to the registrant.

8. A kiosk as claimed in claim 7, wherein said means for obtaining personal data from a registrant is a biometrics data input device.

9. A kiosk as claimed in claim 7, wherein said means for obtaining personal data from a registrant is a device for capturing an image of the registrant.

10. A kiosk as claimed in claim 7, wherein said means for obtaining personal data from a registrant includes both a device for capturing an image of the registrant and a biometrics data input device.

11. A kiosk as claimed in claim 7, wherein said portable storage device is a write once read many times (WORM) optical card.

12. A kiosk as claimed in claim 7, wherein said means for obtaining personal data from a registrant is a biometrics reader device, and further comprising;
a second reader device for inputting biometrics data stored on said portable storage device;
means for comparing customer input biometrics data with stored biometrics data and authorizing a transaction based on results of the transaction,
whereby authorization of transactions based on said input and stored biometrics data may be carried out without connection to a central database or an on-site database of biometrics data.

13. An arrangement as claimed in claim 12, further comprising, within said housing, a display screen, a microprocessor, operating system software, and an on-site storage device for storing applications programs, whereby processing of data stored on the portable storage device is carried out by software stored in said on-site storage device and executed by the microprocessor, results of said processing being displayed on said display screen.

14. An arrangement as claimed in claim 13, further comprising a printer situated within said housing for printing results of said processing.

15. An arrangement as claimed in claim 12, further comprising, within said housing, a display screen, a microprocessor, and operating system software, and wherein said portable storage device has stored therein applications software for execution by said microprocessor, results of said processing being displayed on said display screen.

16. An arrangement as claimed in claim 12, further comprising network connections for enabling communications with an external computer network, including communication of registration information, while maintaining a real-time on-site verification capability.
